(19) United States
(12) Patent Application Publication
(10) Pub. No.: US 2019/0026461 A1
(43) Pub. Date: Jan. 24, 2019

(54) SYSTEM AND METHOD FOR ELECTRONIC MESSAGING THREAT SCANNING AND DETECTION

(71) Applicant: BARRACUDA NETWORKS, INC., CAMPBELL, CA (US)

(72) Inventors: Asaf Cidon, San Francisco, CA (US); Lior Gavish, San Francisco, CA (US); Michael Perone, Saratoga, CA (US)

(21) Appl. No.: 15/693,367

(22) Filed: Aug. 31, 2017

Related U.S. Application Data
(60) Provisional application No. 62/535,191, filed on Jul. 20, 2017.

(51) Int. Cl. G06F 21/55; H04L 29/06; H04W 12/12; G06N 5/04

(52) U.S. Cl. CPC G06F 21/552; H04L 63/145; G06F 2221/034; H04W 12/12; G06N 5/043; H04L 63/1483

(57) ABSTRACT

A new approach is proposed to support electronic messaging threat scanning and detection to identify security threats missed by an existing security software of an electronic messaging system. An AI engine first retrieves an entire inventory of historical electronic messages by the users on the electronic messaging system over a certain time. The AI engine scans the retrieved inventory of historical electronic messages to identify various types of security threats to the electronic messaging system in the past. The AI engine compares the identified security threats to those that have been identified by the existing security software to identify a set of security threats that had eluded or missed by the existing security software in the past. The AI engine then removes, modifies, or quarantines electronic messages that contain the missed security threats so that none of them will trigger an attack to the electronic messaging system in the future.

### CROSS-REFERENCE TO RELATED APPLICATIONS

This application claims the benefit of U.S. Provisional Patent Application No. 62/535,191, filed Jul. 20, 2017, and entitled “AI-BASED REAL-TIME COMMUNICATION FRAUD DETECTION AND PREVENTION,” which is incorporated herein in its entirety by reference.

### BACKGROUND

Cyber criminals are increasingly utilizing social engineering and deception to successfully conduct wire fraud and extract sensitive information from their targets. Spear phishing, also known as Business Email Compromise, is a cyber fraud where the attacker impersonates an employee and/or a system of the company by sending emails from a known or trusted sender in order to induce targeted individuals to wire money or reveal confidential information, is rapidly becoming the most devastating new cybersecurity threat. The attackers frequently embed personalized information in their electronic messages including names, emails, and signatures of individuals within a protected network to obtain funds, credentials, wire transfers and other sensitive information. Countless organizations and individuals have fallen prey, sending wire transfers and sensitive customer and employee information to attackers impersonating, e.g., their CEO, boss, or trusted colleagues. Note that such impersonation attacks do not always have to impersonate individuals, they can also impersonate a system or component that can send or receive electronic messages. For a non-limiting example, a networked printer on a company's internal network has been used by the so-called printer repo scam to initiate impersonation attacks against individuals of the company.

Unlike traditional threats, contemporary attacks via impersonated communication fraud such as spear phishing may not involve malware, viruses, or other flags that are typically screened for by conventional anti-virus/malware software. In addition, most impersonation attacks are unique (e.g., “zero-day”), making them hard to catch with hard-coded pattern-matching techniques typically adopted by conventional email security solutions. As a result, existing email security solutions are often inadequate to address the increasing threats presented by these new sophisticated communication fraud attempts, requiring a novel approach to deal with these evolving threats.

The foregoing examples of the related art and limitations related therewith are intended to be illustrative and not exclusive. Other limitations of the related art will become apparent upon a reading of the specification and a study of the drawings.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 depicts an example of a system diagram to support communication fraud detection and prevention in accordance with some embodiments.

FIG. 2 depicts a flowchart of an example of a process to support communication fraud detection and prevention in accordance with some embodiments.

FIG. 3 depicts a flowchart of an example of a process to support anti-fraud user training and protection in accordance with some embodiments.

FIG. 4 depicts a flowchart of an example of a process to support electronic messaging threat scanning and detection in accordance with some embodiments.

### DETAILED DESCRIPTION OF EMBODIMENTS

The following disclosure provides many different embodiments, or examples, for implementing different features of the subject matter. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

A new approach is proposed that contemplates systems and methods to support electronic messaging threat scanning and detection by utilizing an artificial intelligence (AI) engine that scans inventory of historical electronic messages by users of an entity on an electronic messaging system to identify and fix security threats missed by an existing security software of the electronic messaging system. First, the AI engine is configured to retrieve an entire inventory of historical electronic messages by the users on the electronic messaging system over a certain time via an application programming interface (API) call to the electronic messaging system. The AI engine then scans the retrieved inventory of historical electronic messages to identify a plurality of various types of security threats to the electronic messaging system in the past. The AI engine compares the identified security threats to those that have been identified by an existing security software of the electronic messaging system to identify a set of security threats that had eluded or missed by the existing security software in the past. The AI engine then removes, modifies, or quarantines a set of the historical electronic messages that contain at least one of the missed security threats from the electronic messaging system so that none of the missed security threats will trigger an attack to the electronic messaging system in the future. The AI engine may also fix one or more vulnerabilities in the electronic messaging system by enforcing additional security checks for communication fraud in incoming electronic messages in real time in addition to the existing security software of the electronic messaging system.

Through in-depth analysis of the entire inventory of historical communications of the users of the entity on the electronic messaging system, the proposed approach is capable of identifying security threats, such as impersonating attacks, which might have been missed by a conventional security software of the electronic messaging system as discussed above. Identifying and removing such missed security threats from the electronic messaging system is important because such threats may be latent and, if left unattended, they may still be triggered by an outside intruder to initiate attack the entity and/or the electronic messaging system.

As used hereinafter, the term “user” (or “users”) refers not only to a person or human being, but also to a system or component that is configured to send and receive electronic messages and is thus also subject to an impersonation attack. For non-limiting examples, such system or component can be but is not limited to a network printer on the entity's internal network, a web-based application used by individuals of the entity, etc.

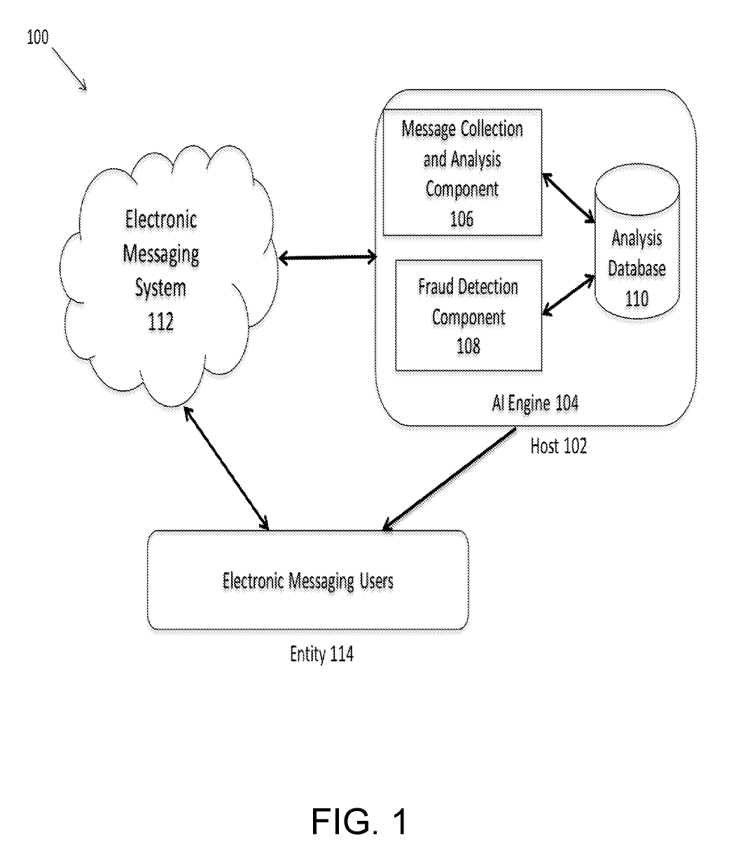

FIG. 1 depicts an example of a system diagram 100 to support communication fraud detection and prevention. Although the diagrams depict components as functionally separate, such depiction is merely for illustrative purposes. It will be apparent that the components portrayed in this figure can be arbitrarily combined or divided into separate software, firmware and/or hardware components. Furthermore, it will also be apparent that such components, regardless of how they are combined or divided, can execute on the same host or multiple hosts, and wherein the multiple hosts can be connected by one or more networks.

In the example of FIG. 1, the system 100 includes at least an AI engine 104 having a message and analysis component 106 and a fraud detection component 108, an associated analysis database 110, each running on one or more computing unit/appliance/hosts 102 with software instructions stored in a storage unit such as a non-volatile memory (also referred to as secondary memory) of the computing unit for practicing one or more processes. When the software instructions are executed, at least a subset of the software instructions is loaded into memory (also referred to as primary memory) by one of the computing units of the host 102, which becomes a special purposed one for practicing the processes. The processes may also be at least partially embodied in the host 102 into which computer program code is loaded and/or executed, such that, the host becomes a special purpose computing unit for practicing the processes. When implemented on a general-purpose computing unit, the computer program code segments configure the computing unit to create specific logic circuits.

In the example of FIG. 1, each host 102 can be a computing device, a communication device, a storage device, or any computing device capable of running a software component. For non-limiting examples, a computing device can be but is not limited to a laptop PC, a desktop PC, a tablet PC, or an x86 or ARM-based a server running Linux or other operating systems.

In the example of FIG. 1, the electronic messaging system 112 can be but is not limited to, Office365/Outlook, Slack, LinkedIn, Facebook, Gmail, Skype, Google Hangouts, Salesforce, Zendesk, Twilio, or any communication platform capable of providing electronic messaging services to (e.g., send, receive, and/or archive electronic messages) to users within the entity 114. Here, the electronic messaging system 112 can be hosted either on email servers (not shown) associated with the entity 112 or on services/servers provided by a third party. The servers are either located locally with the entity or in a cloud. The electronic messages being exchanged on the electronic messaging system 112 include but are not limited to emails, instant messages, short messages, text messages, phone call transcripts, and social media posts, etc.

In the example of FIG. 1, the host 102 has a communication interface (not shown), which enables the AI engine 104 and/or the analysis database 106 running on the host 102 to communicate with electronic messaging system 112 and client devices (not shown) associated with users within an entity/organization/company 114 following certain communication protocols, such as TCP/IP, http, https, ftp, and sftp protocols, over one or more communication networks (not shown). Here, the communication networks can be but are not limited to, internet, intranet, wide area network (WAN), local area network (LAN), wireless network, Bluetooth, WiFi, and mobile communication network. The physical connections of the network and the communication protocols are well known to those of skill in the art. The client devices are utilized by the users within the entity 114 to interact with (e.g., send or receive electronic messages to and from) the electronic messaging system 112, wherein the client devices reside either locally or remotely (e.g., in a cloud) from the host 102. In some embodiments, the client devices can be but are not limited to, mobile/hand-held devices such as tablets, iPhones, iPads, Google's Android devices, and/or other types of mobile communication devices, PCs, such as laptop PCs and desktop PCs, and server machines.

During the operation of the system 100, the message collection and analysis component 106 of the AI engine 104 is configured to access and collect/retrieve all historical electronic messages (e.g., emails) sent or received by each user within on the entity 114 on each electronic messaging system 112. In some embodiments, the AI engine 104 is optionally authorized by the entity/organization 114 via online authentication protocol (OATH) to access one or more electronic messaging systems 112 used by the users of the entity 114 to exchange electronic messages. In some embodiments, the message collection and analysis component 106 is configured to retrieve the electronic messages automatically via programmable calls to one or more Application Programming Interfaces (APIs) to each electronic communication platform 112. Such automatic retrieval of electronic messages eliminates the need for manual input of data as required when, for a non-limiting example, scanning outgoing emails in relation to data leak prevention (“DLP”) configured to scan and identify leakage or loss of data. Through the API calls, the message collection and analysis component 106 is configured to retrieve not only external electronic messages exchanged between the users of the entity 114 and individual users outside of the entity 114, but also internal electronic messages exchanged between users within the entity 114, which expands the scope of communication fraud detection to cover the scenario where security of one user within the entity 114 has been compromised. In some embodiments, the message collection and analysis component 106 is configured to retrieve electronic messages sent or received on the electronic messaging system 112 over a certain period time, e.g., day, month, year, or since beginning of use. The electronic messages retrieved over a shorter or more recent time period may be used to identify recent communication patterns while the electronic messages retrieved over a longer period of time can be used to identify more reliable longer term communication patterns. In some embodiments, the message collection and analysis component 106 is configured to collect the electronic messages from an electronic messaging server (e.g., an on-premises Exchange server) by using an installed email agent on the electronic messaging server or adopting a journaling rule (e.g., Bcc all emails) to retrieve the electronic messages from the electronic messaging server (or to block the electronic messages at a gateway).

Once the electronic messages have been collected, the message collection and analysis component 106 of the AI engine 104 is configured to examine and extract various features from the collected electronic messages for communication pattern detection. For non-limiting examples, the electronic messages are examined for one or more of names of sender and recipient(s), email addresses and/or domains of the sender and the recipient(s), timestamp, and metadata of the electronic messages. In some embodiments, the message collection and analysis component 106 is further configured to examine content of the electronic messages to extract sensitive information (e.g., legal, financial, position of the user within the entity 114, etc.)

In some embodiments, the message collection and analysis component 106 is configured to build a feature vector that includes the various features extracted from the electronic messages and feed the feature vector through an AI-based classification in order to identify existing communication patterns/profiles of each individual users within the entity 114. Here, the AI-based classification can use one or more of a random forest approach, a support vector machine, a neural network, or a linear regression. Such classification can be based on one or more features including but not limited to name and messaging identity (e.g., email address) of the sender, recipient, reply-to, CC, and BCC, the frequency of communications between individual users, the text and attachments used in the messages, the tone of communication, the position of certain phrases within the message, the signature used by individuals, the time of day of the messages, the signature used to sign the messages (e.g., using DKIM and/or SPF), the length of the messages, links embedded in the messages. The communication patterns identified for the electronic messages received by each individual user through AI-based classification include statistics (or stats) on one or more of number (how many times), frequency, and/or distribution of the electronic messages received over time, the characterization (e.g., email addresses and/or domains) of senders of the electronic messages, tone, length, and/or style of the electronic messages, and links embedded within the electronic messages. For a non-limiting example, one user handling sensitive accounting information for the entity 114 may tend to experience a peak in business-related emails containing financial information towards the end of each quarter and the most of the such emails containing sensitive information are originated by other users within the entity 114 (vs. external emails from outside of the entity 114). Once the communication patterns have been identified for each user within the entity 114, such communication patterns and their relevant information are saved into an analysis database 110, which maintains the communication patterns that may later be used to detection communication fraud in real time as discussed in details below.

Once the communication patterns of each user within the entity 114 have been identified, they can be utilized for real time communication fraud detection. As soon as one or more new/incoming messages have been received on the electronic messaging system 112, they are retrieved (or intercepted) by the message collection and analysis component 106 in real time. In some embodiments, the message collection and analysis component 106 is configured to retrieve the incoming electronic messages before the intended recipient of the incoming messages in the entity 114. The fraud detection component 108 of the AI engine 104 is then configured to use the unique communication patterns identified and stored in the analysis database 110 to examine and detect anomalous signals in attributes in the metadata and/or content of the retrieved electronic messages. Here, the anomalous signals include but are not limited to, a same sender using another email address for the first time, replying to someone else in the email/electronic message chain, or sudden change in number of recipients of an electronic message.

Based on the detected anomalous signals, the fraud detection component 108 is configured to determine with a high degree of accuracy whether the incoming messages received is part of an impersonating (e.g., spear phishing) attack or other kinds of communication fraud and/or former/ongoing network threats, which include but are not limited to a personalized phishing attempt which entices the recipient to click on a link which may ask them to enter their credentials or download a virus, or an attacker hijacking an internal account and using it to communicate with other users in the organization or external parties. If so, such incoming messages are fraudulent and the fraud detection component 108 is configured to block (remove, delete, modify) or quarantine such fraudulent messages on the electronic messaging system 112 in real time, and notify the intended recipient(s) of the electronic message and/or an administrator of the electronic communication platform of the attempted attack. The intended recipient of the electronic message and/or the administrator of the electronic communication platform may then take actions accordingly to prevent the same attack from happening again in the future (e.g., by blacklisting the sender of the fraudulent messages).

In some embodiments, unlike existing services, the fraud detection component 108 of the AI engine 104 is configured to detect the fraudulent incoming messages that are part of a longer conversation that includes more than one electronic message, e.g., a chain of emails. Rather than simply examining the first message of the conversation, the fraud detection component 108 is configured to monitor all electronic messages in the conversation continuously in real time and will flag an electronic message in the conversation for block or quarantine at any point once a predetermined set of anomalous signals are detected.

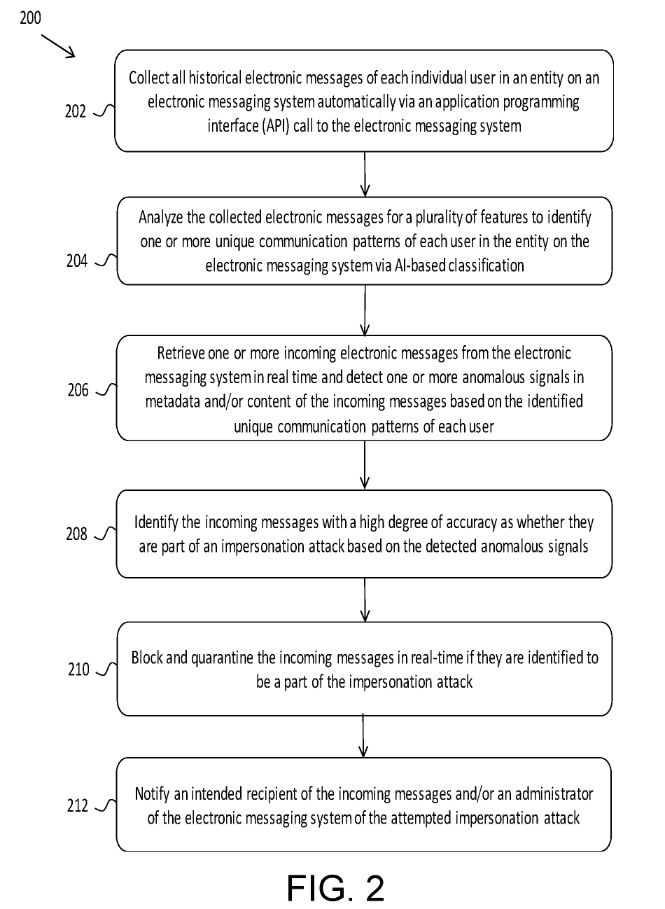

FIG. 2 depicts a flowchart 200 of an example of a process to support communication fraud detection and prevention. Although the figure depicts functional steps in a particular order for purposes of illustration, the processes are not limited to any particular order or arrangement of steps. One skilled in the relevant art will appreciate that the various steps portrayed in this figure could be omitted, rearranged, combined and/or adapted in various ways.

In the example of FIG. 2, the flowchart 200 starts at block 202, where all historical electronic messages of each individual user in an entity on an electronic messaging system are collected automatically via an application programming interface (API) call to the electronic messaging system. The flowchart 200 continues to block 204, where the collected electronic messages are analyzed to extract a plurality of features to identify one or more unique communication patterns of each user in the entity on the electronic messaging system via AI-based classification. The flowchart 200 continues to block 206, where one or more incoming electronic messages are retrieved from the electronic messaging system in real time and one or more anomalous signals in metadata and/or content of the incoming messages are detected based on the identified unique communication patterns of each user. The flowchart 200 continues to block 208, where the incoming messages are identified with a high degree of accuracy as whether they are part of an impersonation attack based on the detected anomalous signals. The flowchart 200 continues to block 210, where the incoming messages are blocked and quarantined in real time if they are identified to be a part of the impersonation attack. The flowchart 200 ends at block 212, where an intended recipient of the incoming messages and/or an administrator of the electronic messaging system are notified of the attempted impersonation attack.

In some embodiments, in addition to identifying and blocking attempts of communication fraud as discussed above, the message collection and analysis component 106 of the AI engine 104 is configured to analyze contents and/or types of the historical electronic messages collected from the electronic messaging system 112 via AI-based classification to identify one or more high-risk individual users of the electronic messaging system 112 within the entity 114. Such content-based analysis of the electronic messages each individual user receives or sends is in addition to or in alternative to the identification of the communication patterns of the individual users. In some embodiments, the message collection and analysis component 106 is configured to calculate a security score for each individual in the entity 114 based on the analysis of his/her historical electronic messages, wherein an individual is identified as high-risk if his/her security score is above a predetermined threshold, indicating he/she is at high risk and is most likely to be targeted in an impersonation attack (e.g., spear phishing). In some embodiments, the message collection and analysis component 106 is configured to report such high-risk individual users to the administrator of the electronic messaging system 112 so that extra precautionary measures specific to these high-risk individual users can be taken.

In some embodiments, the message collection and analysis component 106 is configured to customize/personalize such identification towards the unique context of each individual user, which includes but is not limited to one or more of position, job title or responsibility, and/or day-to-day activities of each individual user. For non-limiting examples, by analyzing the contents of the electronic messages, the message collection and analysis component 106 is configured to identify such high-risk individual users (i.e., sender or receiver of such electronic messages) who are, for non-limiting examples, executives (e.g., CEO, CTO, VP, etc.) of the entity 114, individual users who handle financial, human resource, legal and other sensitive information of the entity 114 on a regular basis, and/or individual users who conduct perform certain sensitive functionalities, e.g., wire transfer or bank transfer, etc. for the entity 114.

Once those high-risk individual users have been identified, the fraud detection component 108 of the AI engine 104 is configured to generate and launch one or more simulated impersonating/phishing attacks targeting against those identified high-risk individual users to test their security awareness and to prevent them from suffering damage when real attacks actually happen. Like genuine impersonation attacks, the simulated attacks are generated by the fraud detection component 108 as one or more simulated fraud messages that can appear to be coming from someone within the entity 114 even though they are not. In some embodiments, the message collection and analysis component 106 is configured to generate the one or more simulated fraud messages as a part of a message chain or conversation that includes more than one simulated fraud message as part of the simulated attack.

In some embodiments, the message collection and analysis component 106 of the AI engine 104 is then configured to collect and analyze responses by those high-risk individual users to the simulated attacks in real time to identify issues and/or weaknesses in the responses. In some embodiments, the message collection and analysis component 106 is configured to store the analysis results of responses to the simulated attacks to the analysis database 110 for further actions. In some embodiments, the fraud detection component 108 of the AI engine 104 is configured to take corresponding actions to prevent those high-risk individual users from suffering damages in case of real attacks based on the identified weaknesses in their responses. For a non-limiting example, if an accounting individual handling financial transactions in the entity 114 on a daily basis failed to recognize a simulated impersonation attack, the fraud detection component 108 may modify the individual's electronic message processing flow on the electronic messaging system 112 so that all future electronic messages to the individual that involves financial transactions are automatically intercepted and analyzed by the message collection and analysis component 106 for risk analysis before the individual is allowed to receive and/or take any action in response to such electronic messages. In some embodiments, the fraud detection component 108 is also configured to provide one or more of guidance, feedback and a list of actionable items to the administrator of the electronic messing platform 112 and/or the entity 114 based on the analysis of the responses so that they may better prepare and train those high-risk individual users against future attacks when they actually happen.

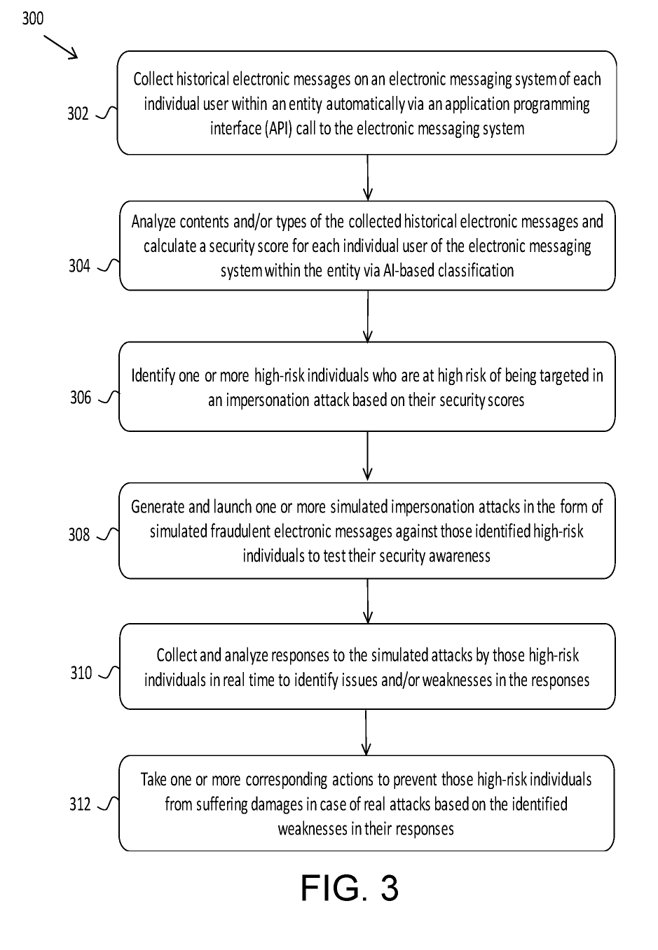

FIG. 3 depicts a flowchart 300 of an example of a process to support anti-fraud user training and protection. In the example of FIG. 3, the flowchart 300 starts at block 302, where historical electronic messages on an electronic messaging system of each individual user within an entity are collected automatically via an application programming interface (API) call to the electronic messaging system. The flowchart 300 continues to block 304, where contents and/or types of the collected historical electronic messages are analyzed and a security score is calculated for each individual user of the electronic messaging system within the entity via AI-based classification. The flowchart 300 continues to block 306, where one or more high-risk individual users who are at high risk of being targeted in an impersonation attack are identified based on their security scores. The flowchart 300 continues to block 308, where one or more simulated impersonation attacks in the form of simulated fraudulent electronic messages are generated and launched against those identified high-risk individual users to test their security awareness. The flowchart 300 continues to block 310, where responses to the simulated attacks by those high-risk individual users are collected and analyzed in real time to identify issues and/or weaknesses in the responses. The flowchart 300 ends at block 312, where one or more corresponding actions are taken to prevent those high-risk individual users from suffering damages in case of real attacks based on the identified weaknesses in their responses.

In some embodiments, the message collection and analysis component 106 of the AI engine 104 is configured to retrieve an entire inventory of historical electronic messages by users of an entity 114 on an electronic messaging system 112 over a certain time frame (e.g., the entire email inventory of a company over the past year) via API calls to the electronic messaging system 112. Once the inventory of historical electronic messages has been retrieved, the fraud detection component 108 of the AI engine 104 is configured to scan them to identify a plurality of various types of security threats to the electronic messaging system in the past. Such security threats include but are not limited to, viruses, malware, phishing emails, communication frauds and/or other types of impersonation attacks. Here, the fraud detection component 108 is configured to identify not only the communication frauds and/or other types of impersonation attacks (e.g., spear phishing attacks) and/or high-risk individuals through electronic message scanning as discussed above, it is also configured to scan the historical electronic messages for other more “traditional” threats, such as viruses, malware, ransomware, phishing and spam.

Since conventional anti-virus/malware software may not be able to recognize or identify many of the contemporary impersonation attacks as discussed above, the fraud detection component 108 is further configured to compare the plurality of identified security threats against those that have been identified by an existing security (e.g., anti-virus/malware) software of the electronic messaging system 112 to identify a set of security threats that had eluded or missed by the existing security software in the past, wherein such security threats would have been identified had the AI engine 104 been adopted. In some embodiments, the fraud detection component 108 is configured to save and maintain the identified set of missed security threats in the analysis database 110. Note that some of the missed security threats may still leave the entity 114 and its users vulnerable even if they may not have been triggered attack to the electronic messing system 112 in the past. In some cases, some of the missed security threats are latent threats, which, like time bombs, once triggered by an attacker or a user (e.g., recipient of a fraudulent email), may launch an attack to the entity 114 via the electronic messaging system 112 in the future. For a non-limiting example, certain fraudulent emails may include an infected file attachment, which may not launch an attack immediately. But once the attachment is opened by the user or an embedded link clicked by the user, it would trigger an attack on the electronic messaging system 112.

In some embodiments, the fraud detection component 108 of the AI engine 104 is configured to remove, delete, modify, or quarantine historical electronic messages that contain at least one of the missed security threats from the electronic messing system 112. Doing so would eliminate the possibility that any of the missed security threats may trigger an attack to the electronic messing system in the future. In some embodiments, the fraud detection component 108 of the AI engine 104 is configured to fix or amend the vulnerabilities in the electronic messaging system 112 by enforcing additional security checks for communication fraud in incoming electronic messages in real time in addition to the existing security software of the electronic messaging system 112 so that no security threats will be missed in the future. In some embodiments, the fraud detection component 108 is configured to enforce the additional security checks for communication fraud based on the identified communication patterns of the users and/or the identified high-risk individual users in the entity 114 as discussed above.

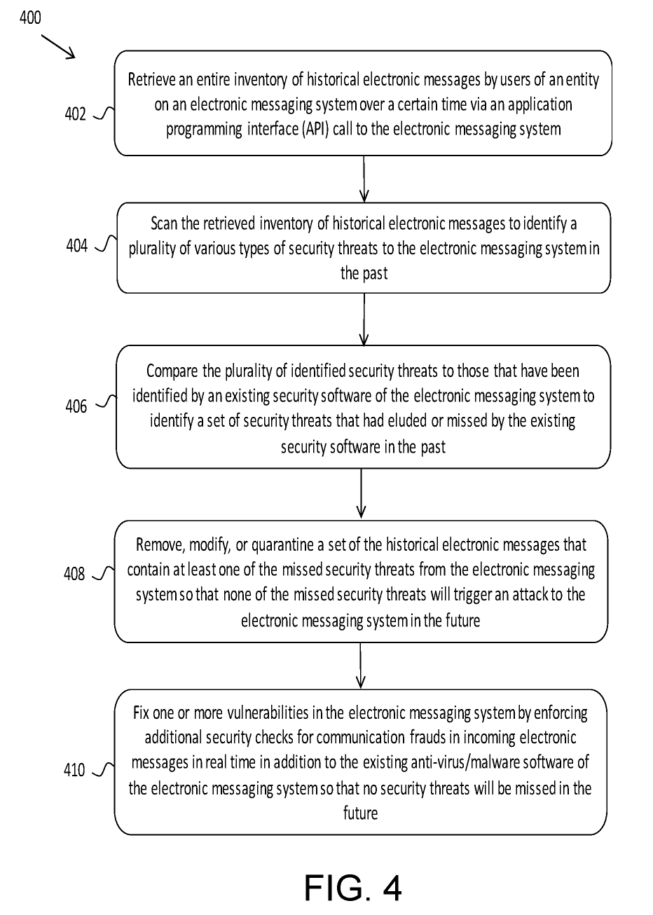

FIG. 4 depicts a flowchart 400 of an example of a process to support electronic messaging threat scanning and detection. In the example of FIG. 4, the flowchart 400 starts at block 402, where an entire inventory of historical electronic messages by users of an entity on an electronic messaging system over a certain time frame are retrieved via an application programming interface (API) call to the electronic messaging system. The flowchart 400 continues to block 404, where the retrieved inventory of historical electronic messages is scanned to identify a plurality of various types of security threats to the electronic messaging system in the past. The flowchart 400 continues to block 406, where the plurality of identified security threats are compared to those that have been identified by an existing security software of the electronic messaging system to identify a set of security threats that had eluded or missed by the existing security software in the past. The flowchart 400 continues to block 408, where a set of the historical electronic messages that contain at least one of the missed security threats are removed, modified, or quarantined from the electronic messing system so that none of the missed security threats will trigger an attack to the electronic messaging system in the future. The flowchart 400 ends at block 410, where one or more vulnerabilities in the electronic messaging system are fixed by enforcing additional security checks for communication frauds in incoming electronic messages in real time in addition to the existing security software of the electronic messaging system so that no security threats will be missed in the future.

One embodiment may be implemented using a conventional general purpose or a specialized digital computer or microprocessor(s) programmed according to the teachings of the present disclosure, as will be apparent to those skilled in the computer art. Appropriate software coding can readily be prepared by skilled programmers based on the teachings of the present disclosure, as will be apparent to those skilled in the software art. The invention may also be implemented by the preparation of integrated circuits or by interconnecting an appropriate network of conventional component circuits, as will be readily apparent to those skilled in the art.

The methods and system described herein may be at least partially embodied in the form of computer-implemented processes and apparatus for practicing those processes. The disclosed methods may also be at least partially embodied in the form of tangible, non-transitory machine readable storage media encoded with computer program code. The media may include, for example, RAMs, ROMs, CD-ROMs, DVD-ROMs, BD-ROMs, hard disk drives, flash memories, or any other non-transitory machine-readable storage medium, wherein, when the computer program code is loaded into and executed by a computer, the computer becomes an apparatus for practicing the method. The methods may also be at least partially embodied in the form of a computer into which computer program code is loaded and/or executed, such that, the computer becomes a special purpose computer for practicing the methods. When implemented on a general-purpose processor, the computer program code segments configure the processor to create specific logic circuits. The methods may alternatively be at least partially embodied in a digital signal processor formed of application specific integrated circuits for performing the methods.

What is claimed is:

1. A system to support electronic messaging threat scanning and detection, comprising:
an artificial intelligence (AI) engine running on a host, which in operation, is configured to
retrieve an entire inventory of historical electronic messages by users of an entity on an electronic messaging system over a certain time via an application programming interface (API) call to the electronic messaging system;
scan the retrieved inventory of historical electronic messages to identify a plurality of various types of security threats to the electronic messaging system in the past;
compare the plurality of identified security threats to those that have been identified by an existing security software of the electronic messaging system to identify a set of security threats that had eluded or missed by the existing security software in the past;
remove, modify, or quarantine a set of the historical electronic messages that contain at least one of the missed security threats from the electronic messaging system so that none of the missed security threats will trigger an attack to the electronic messaging system in the future.

2. The system of claim 1, wherein:
the electronic messaging system is one of Office365/Outlook, Slack, LinkedIn, Facebook, Gmail, Skype, Salesforce, and any communication platform configured to send and/or receive the electronic messages to and/or from users within the entity.

3. The system of claim 1, wherein:
each user is either a person or a system or component configured to send and receive the electronic messages.

4. The system of claim 1, wherein:
the AI engine is configured to collect not only external electronic messages exchanged between the users of the entity and individual users outside of the entity, but also internal electronic messages exchanged between users within the entity.

5. The system of claim 1, wherein:
the AI engine is configured to collect the electronic messages from an electronic messaging server by using an installed email agent on the electronic messaging server or adopting a journaling rule to retrieve the electronic messages from the electronic messaging server.

6. The system of claim 1, wherein:
the various types of the plurality of identified security threats include one or more of viruses, malware, phishing emails, communication frauds and other types of impersonating attacks.

7. The system of claim 6, wherein:
the AI engine is configured to identify not only the communication frauds and/or other types of impersonating attacks but also the viruses and malwares by scanning the retrieved inventory of historical electronic messages.

8. The system of claim 1, wherein:
the AI engine is configured to save and maintain the identified set of missed security threats in an analysis database.

9. The system of claim 1, wherein:
the AI engine is configured to detect some of the missed security threats that still leave the entity and its users vulnerable even if they have not been triggered attack to the electronic messing system in the past.

10. The system of claim 9, wherein:
the AI engine is configured to detect some of the missed security threats as latent threats, which, once triggered by an attacker or a user, launch an attack to the entity via the electronic messaging system.

11. The system of claim 1, wherein:
the AI engine is configured to fix one or more vulnerabilities in the electronic messaging system by enforcing additional security checks for communication fraud in incoming electronic messages in real time in addition to the existing security software of the electronic messaging system.

12. The system of claim 11, wherein:
the AI engine is configured to enforce the additional security checks for communication fraud based on identified communication patterns of the users and/or identified high-risk individual users in the entity.

13. A computer-implemented method to support electronic messaging threat scanning and detection, comprising:
retrieving an entire inventory of historical electronic messages by users of an entity on an electronic messaging system over a certain time via an application programming interface (API) call to the electronic messaging system;
scanning the retrieved inventory of historical electronic messages to identify a plurality of various types of security threats to the electronic messaging system in the past;
comparing the plurality of identified security threats to those that have been identified by an existing security software of the electronic messaging system to identify a set of security threats that had eluded or missed by the existing security software in the past;
removing, modifying, or quarantining a set of the historical electronic messages that contain at least one of the missed security threats from the electronic messaging system so that none of the missed security threats will trigger an attack to the electronic messaging system in the future.

14. The computer-implemented method of claim 13, further comprising:
collecting not only external electronic messages exchanged between the users of the entity and individual users outside of the entity, but also internal electronic messages exchanged between users within the entity.

15. The computer-implemented method of claim 13, further comprising:
collecting the electronic messages from an electronic messaging server by using an installed email agent on the electronic messaging server or adopting a journaling rule to retrieve the electronic messages from the electronic messaging server.

16. The computer-implemented method of claim 13, further comprising:
identifying not only the communication frauds and/or other types of impersonating attacks but also the viruses and malwares by scanning the retrieved inventory of historical electronic messages.

17. The computer-implemented method of claim 13, further comprising:
saving and maintaining the identified set of missed security threats in an analysis database.

18. The computer-implemented method of claim 13, further comprising:
detecting some of the missed security threats that still leave the entity and its users vulnerable even if they have not been triggered attack to the electronic messing system in the past.

19. The computer-implemented method of claim 18, further comprising:
detecting some of the missed security threats as latent threats, which, once triggered by an attacker or a user, launch an attack to the entity via the electronic messaging system.

20. The computer-implemented method of claim 13, further comprising:
fixing one or more vulnerabilities in the electronic messaging system by enforcing additional security checks for communication fraud in incoming electronic messages in real time in addition to the existing security software of the electronic messaging system.

21. The computer-implemented method of claim 20, further comprising:
enforcing the additional security checks for communication fraud based on identified communication patterns of the users and/or identified high-risk individual users in the entity.
